(19) United States
(12) Patent Application Publication
(10) Pub. No.: US 2008/0243432 A1
(43) Pub. Date: Oct. 2, 2008

(54) Pedometer

(76) Inventors: Kazuo Kato, Chiba-shi (JP); Akira Takakura, Chiba-shi (JP)

Correspondence Address: BRUCE L. ADAMS, ESQ;ADAMS & WILKS, 17 BATTERY PLACE, SUITE 1231, NEW YORK, NY, 10004, US

(21) Appl. No.: 12/077,661

(22) Filed: Mar. 20, 2008

(30) Foreign Application Priority Data
Mar. 26, 2007 (JP) 2007-079392

(51) Int. Cl. G01C 22/00

(52) U.S. Cl. 702/160

(57) ABSTRACT

It is made possible to reduce electric power consumption while suppressing an occurrence of a walking detection leak. By a cycle operation section and a cycle comparison section in a CPU, if it is judged that a walking signal from a detection circuit is within a predetermined cycle, the walking signal is counted as a step number by a step number count section. In a case where the walking signal within the predetermined cycle is not detected for a predetermined time by the cycle comparison section, a walking stop detection section judges to be a walking stop, an electric source control processing section controls an electric source control circuit to thereby switch the detection circuit to an intermittent drive from a continuous drive, and thereafter gradually prolongs a pause time of the intermittent drive for a predetermined time at a time in every time the walking signal within the predetermined cycle is not detected for the predetermined time.

### BACKGROUND OF THE INVENTION

1. Field of the Invention

The present invention relates to a pedometer measuring a step number.

2. Description of the Related Art

From olden times, there is developed the pedometer measuring the step number of a measured person, which is used by being worn to a body of the measured person or by being accommodated in a bag or the like, that the measured person carries.

In the above pedometer, since a battery is used as an electric source, there is applied an electric power conservation countermeasure.

For example, in JP-A-2005-267152 Gazette, there is disclosed a pedometer in which an acceleration sensor (piezoelectric element) accommodated in a main body of a wristwatch detects a walking vibration and outputs a walking signal, and the walking signal is amplified by an amplification circuit and a filter circuit and binarized by a comparator circuit, thereby counting the step number.

In the above pedometer, in order to reduce an electric power consumption by stopping a defection operation when a user is sleeping and thus not carrying it or when the bag accommodating the pedometer is placed, there is constituted such that, if it becomes that the walking signal is not inputted for a predetermined time (sleeping shift time) by stopping the walking, a sensor circuit switches from a continuous operation to an intermittent operation in which an OFF operation of a predetermined time (pause time) and an ON operation of a predetermined time (operation time) are alternately repeated.

In order to contrive the electric power conservation, although it is necessary to prolong the above pause time, there is an issue that, in a case where the pause time concerned is long, there becomes high a fear that a walking detection leak occurs. On the other hand, in a case where the pause time concerned is short, there is an issue that it becomes difficult to reduce the electric power consumption.

In JP-A-2001-143048, there is disclosed a pedometer in which, in order to detect a walking start, an A/D conversion is performed by sampling an acceleration sensor output at a 20 millisecond interval and, if the walking start is detected, a noise detection after the walking is reduced by being made OFF for 300 millisecond and, in a case where there continues a state in which there is no detection signal of the walking, there becomes an electric power conservation mode, thereby making OFF a sensor for 1-5 second(s).

However, in the above pedometer, in a case where a sampling frequency is low, since a measured step number accuracy decreases, the sampling frequency cannot be decreased to lower than a constant value, so that there is an issue that it is difficult to reduce the electric power consumption.

In JP-A-2006-293860, although there is disclosed a pedometer made such that a sampling cycle is changed between a non-walking time and a walking time, there is an issue similar to the JP-A-2001-143048.

Further, in JP-A-2006-293861, although there is discloses a pedometer in which the sampling cycle at the non-walking time is made longer than the sampling cycle at the walking time, in relation also to this, there is the issue similar to the JP-A-2001-143048 Gazette.

### SUMMARY OF THE INVENTION

In the present invention, it is made a problem to make it possible to reduce the electric power consumption while suppressing an occurrence of the walking detection leak.

According to the present invention, there is provided a pedometer having a detection means having a sensor detecting a walking and outputting a walking signal corresponding to the walking detected by the sensor; a calculation means calculating a step number on the basis of the walking signal from the detection means; and a control means which, in a case where the walking signal is not continuously outputted for a predetermined time from the detection means, controls an operation of the detection means so as to shift from a continuous operation continuously detecting the walking to an intermittent operation in which there are alternately repeated a pause operation pausing a walking detection in a pause time and a detection operation performing the walking detection in a detection time; wherein the control means controls the detection means such that the pause time becomes gradually long in a case where the walking signal is not outputted from the detection means at a time of the intermittent operation.

The control means controls the detection means such that the pause time becomes gradually long in the case where the walking signal is not outputted from the detection means at the time of the intermittent operation.

Here, there may be constituted such that the control means controls the detection means such that an upper limit of the pause time becomes a predetermined time.

Further, there may be constituted such that, in a case shifting to the intermittent operation again after returning to the continuous operation from the intermittent operation, the control means controls the detection means so as to reopen the intermittent operation by returning the pause time to a minimum value.

According to the present invention, it is made the problem make it possible to reduce the electric power consumption while suppressing the occurrence of the walking detection leak.

### BRIEF DESCRIPTION OF THE DRAWINGS

FIG. 1 is a block diagram of a pedometer concerned with an embodiment of the present invention; and

FIG. 2 is a flowchart showing processings in the embodiment of the present invention.

### DETAILED DESCRIPTION OF THE INVENTION

Hereunder, about a pedometer concerned with an embodiment of the present invention, there is explained by using the drawings.

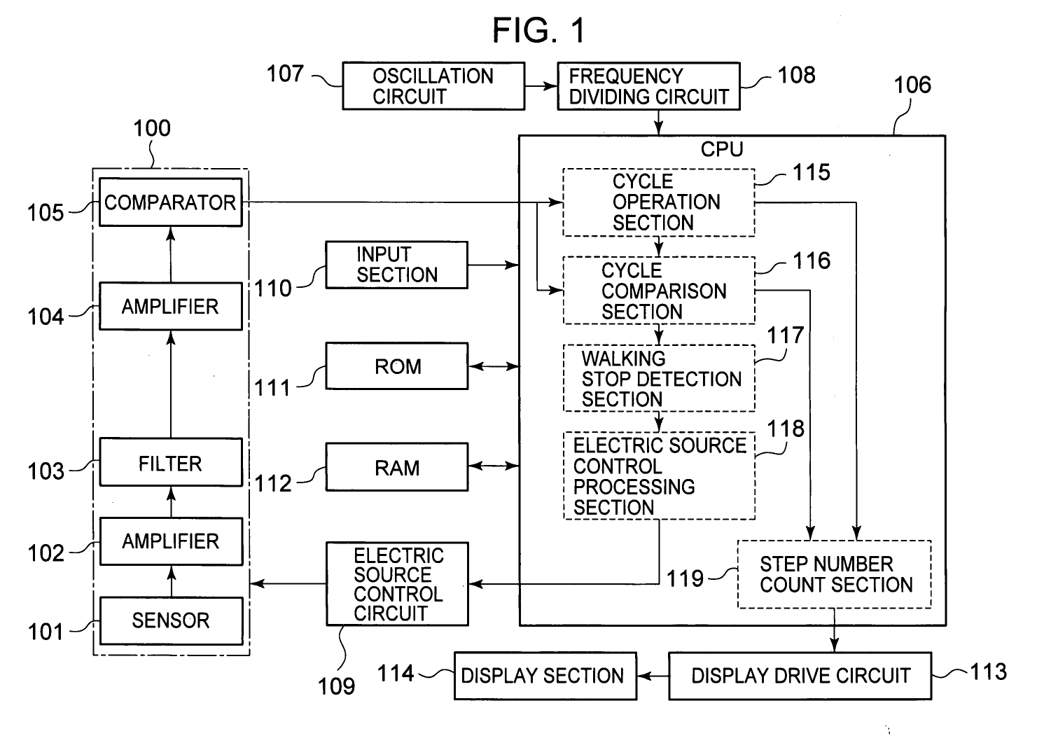

FIG. 1 is a block diagram of the pedometer concerned with the embodiment of the present invention.

In FIG. 1, the pedometer possesses a sensor 101 constituted by a piezoelectric element, and detecting a walking (including a running as well) and outputting a walking signal corresponding to the walking, an amplification circuit (amplifier) 102 amplifying and outputting the walking signal from the sensor 101, a filter 103 causing the walking signal in a signal from the amplification circuit 102 to pass, an amplification circuit (amplifier) 104 amplifying and outputting the walking signal from the filter 103, and a comparator 105 converting the walking signal from the amplification circuit 104 into a binarized digital signal by comparing with a predetermined reference signal, thereby outputting it. The sensor 101, the amplification circuits 102, 104, the filter 103 and the comparator 105 constitute a detection circuit 100.

Further, the pedometer possesses a central processing unit (CPU) 106, an oscillation circuit 107 forming a signal of a predetermined frequency, a frequency dividing circuit 108 frequency-dividing a signal from the oscillation circuit 107 to thereby output a timepiece signal becoming a reference of a clock operation, an electric source control circuit 109 continuously or intermittently supplying, on the basis of a control signal from the CPU 106, a drive electric power to the detection circuit 100 to thereby switch the detection circuit 100 to a continuous operation or an intermittent operation (Details of the intermittent operation are mentioned later.), an input section 110 constituted by a key switch or the like, a read only memory (ROM) 111 storing a program that the CPU 106 implements and the like, a random access memory (RAM) 112 storing a step number data and the like, a display drive circuit 113 driving a display section 114 in response to a display control signal from the CPU 106, and the display section 114 displaying the step number, a time instant and the like.

In FIG. 1, within the CPU 106, functions that the CPU 106 realizes in a case where it implements the program stored in the ROM 111 are shown as the block diagram.

Although details are mentioned later, the CPU 106 functions as a cycle operation section 115 calculating a cycle of the signal from the detection circuit 100, a cycle comparison section 116 judging whether or not it is the walking signal by comparing the cycle of the signal from the detection circuit 100 with a reference value, a walking stop detection section 117 judging to be a walking stop in a case where the cycle, of the signal, judged by the cycle comparison section 116 exceeds a predetermined value, an electric source control processing section 118 intermittently driving the detection circuit in a case where the walking stop detection section 117 judges to be the walking stop, and a step number count section 119 counting the step number on the basis of the walking signal from the cycle comparison section 116.

Incidentally, the detection circuit 100 constitutes a detection means, and the CPU 106, the oscillation circuit 107 and the frequency dividing circuit 108 constitute a clock means. Further, the CPU 106 constitutes a calculation means, and the CPU 106 and the electric source control circuit 109 constitute a control means. Further, the input section 110 constitutes an input means, and the ROM 111 and the RAM 112 constitute a storage means.

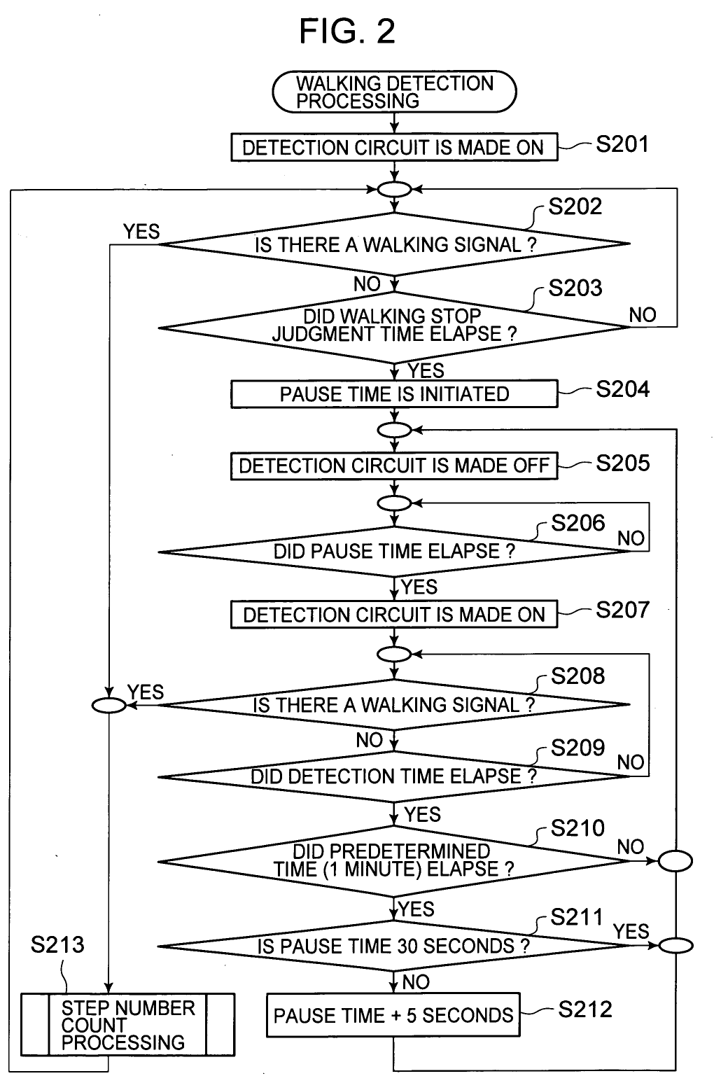

FIG. 2 is a flowchart showing processings in the pedometer concerned with the embodiment of the present invention.

Hereunder, by using FIG. 1 and FIG. 2, there are explained operations in the pedometer concerned with the embodiment of the present invention.

First, if the measured person performs a step number measurement start operation by the input section 110 under a state in which the pedometer (at least the sensor 101) is worn to own arm, the electric source control processing section 118 in the CPU 106 supplies a drive electric power to the detection circuit 100, thereby controlling the electric source control circuit 109 so as to make ON the electric source (a step S201).

The electric source control circuit 109 makes ON the electric source of the detection circuit 100 in response to a control by the electric source control processing section 118.

If the measured person performs the walking, the acceleration sensor 101 detects the walking vibration, thereby outputting the walking signal corresponding to the walking. A signal from the acceleration sensor 101 is amplified by the amplification circuit 102, thereafter a noise component is removed by the filter 103, and the walking signal is inputted to the amplification circuit 104. The walking signal amplified by the amplification circuit 104 is binarized by being compared with a predetermined reference value by the comparator 105, and inputted to the CPU 106 as the digital signal.

The cycle operation section 115 operates a cycle of the signal from the detection circuit 100. The cycle comparison section 116 compares the cycle that the cycle operation section 115 calculated with the reference value, thereby judging whether or not it is the walking signal corresponding to the walking of the measured person (a step S202).

In a case where, in the processing step S202, it is the cycle within a predetermined range, the cycle comparison section 116 judges to be a normal walking signal, and outputs the signal (walking signal) from the detection circuit 100 to the step number count section 119. The step number count section 119 counts the above walking signal, thereby performing a step number count (a step S213).

The step number that the step number count section 119 counted is displayed by the display section 114 through the display drive circuit 113.

If the measured person stops the walking, the signal from the detection circuit 100 exceeds the cycle within the predetermined range, and it is judged that the cycle comparison section 116 is not the walking signal. The walking stop detection section 117 judges whether or not a state, in which it is judged that the cycle comparison section 116 is not the walking signal, went through a predetermined walking stop judgment time (e.g., 5 seconds) (a step S203).

In a case where it was judged in the processing step S203 that the state, in which it is judged that it is not the walking signal, exceeded the predetermined walking stop judgment time, the walking stop detection section 117 judges to be a walking stop because the walking signal is not detected successively during the above walking stop judgment time, thereby shifting to the intermittent operation.

In a case entering to the intermittent operation, the electric source control processing section 118 initializes a predetermined pause time, in which a detection operation is paused (pause state) in the intermittent operation, to a minimum time (e.g., 5 seconds) (a step S204), and thereafter the electric source control processing section 118 outputs a control signal to the electric source control circuit 109 so as to make OFF the detection circuit 100 (a step S205). The electric source control circuit 109 responds to the above control signal to thereby pause and make OFF an electric power supply to the detection circuit 100 and, by this, the detection circuit 100 pauses a walking detection operation.

The electric source control processing section 118 maintains the above pause state till a pause time elapses (a step S206), and thereafter outputs the control signal to the electric source control circuit 109 so as to make ON the detection circuit 100 (a step S207). The electric source control circuit 109 responds to the above control signal to thereby supply and make ON an electric power to the detection circuit 100 and, by this, the detection circuit 100 reopens the walking detection operation.

If the detection circuit 100 reopens the walking detection operation and the walking signal by the walking of the measured person is outputted from the detection circuit 100, the cycle operation section 115 operates the cycle of the signal from the detection circuit 100. The cycle comparison section 116 compares the cycle that the cycle operation section 115 calculated with the reference value, thereby judging whether or not it is the walking signal corresponding to the walking of the measured person (a step S208).

In a case where, in the processing step S208, it is the cycle in the predetermined range, the cycle comparison section 116 judges that it is the normal walking signal, and outputs the walking signal from the detection circuit 100 to the step number count section 119. The step number count section 119 counts the above walking signal, thereby performing the step number count (the step S213), and thereafter it returns to the processing step S202, thereby performing a continuous operation.

After returning to the continuous operation, in a case entering to the intermittent operation again, it follows that the intermittent operation is started by returning the pause time to a minimum value by the processing step S204.

The walking stop detection section 117 judges whether or not a state, in which the cycle comparison section 116 judges that the signal from the detection circuit 100 is not the walking signal, went through a predetermined detection time (a step S209).

In a case where it was judged in the processing step S209 that the detection time (e.g., 5 seconds) elapsed, the electric source control processing section 118 judges whether or not a predetermined time (e.g., 1 minute) elapsed (a step S210).

In a case where it was judged in the processing step S210 that the predetermined time elapsed, the electric source control processing section 118 judges whether or not the pause time at present is a predetermined upper limit value (e.g., 30 seconds) (a step S211). In a case where it does not reach the above upper limit value, it is set to a pause time longer than the present by adding a predetermined time (e.g., 5 seconds) to the pause time at present (a step S212), and thereafter it returns to the processing step S205.

Like this, by the cycle operation section 115 and the cycle comparison section 116 in the CPU 106, if it is judged that the walking signal from the detection circuit 100 is within a predetermined cycle, the walking signal is counted as the step number by the step number count section 119. In a case where the walking signal within the predetermined cycle is not detected successively for a predetermined time by the cycle comparison section 116, the walking stop detection section 117 judges to be the walking stop, the electric source control processing section 118 controls the electric source control circuit 109 to thereby switch the detection circuit 100 to an intermittent drive from a continuous drive, and thereafter gradually prolongs the pause time of the intermittent drive for a predetermined time at a time in every time the walking signal within the predetermined cycle is not detected for the predetermined time. Accordingly, since the pause time becomes long as the walking stop time becomes long, it becomes possible to reduce the electric power consumption and it becomes possible to suppress the occurrence of the walking detection leak.

Further, since the electric source control processing section 118 does not limitlessly prolong the pause time and its upper limit is set to the predetermined time, also by this it becomes possible to suppress the occurrence of the walking detection leak.

In a case where it was judged in the processing step S210 that predetermined time did not elapse, the electric source control processing section 118 returns to the processing step S205. Further, in a case where it was judged in the processing step S209 that the detection time did not elapse, the electric source control processing section 118 returns to the processing step S208.

If roughly classified, a walking stop state is classified into three kinds of (i) a temporary walking stop in which, like a signal wait, the walking is reopened in a short time from the walking stop, (ii) a routine walking stop like a case where the person walks to a desk in an office, sits on a seat and performs a desk work, and (iii) a long time walking stop by a non-carriage during the sleeping, and the like.

In the pedometer concerned with the present embodiment, as to a predetermined time (e.g., for 1 minute) after a walking stop-detection, a detection ability from the temporary walking stop to the walking reopening is ensured by the fact that the pause time is made, e.g., 5 seconds, and a walking stop judgment time, e.g., 5 seconds. In a case where the walking signal is not detected also after the above predetermined time after the walking stop detection, there is judged not to be the temporary walking stop, and the pause time is made 10 seconds by increasing 5 seconds for instance. In a case where there continues a state in which there is no walking signal, the pause time is prolonged till 30 seconds by gradually increasing the pause time by 5 seconds at a time in every 1 minute for instance. In a case where the walking signal is detected in a midway, the pause time is returned to 5 seconds of an initial value which is a minimum value.

Like this, since the walking stop judgment time is made a comparatively short time (e.g., 5 seconds), also in a case where the walking is temporarily stopped in the signal wait, it becomes possible to reduce the electric power consumption by stopping the detection circuit 100.

Further, even in a case of the desk work, since an operation of the detection circuit 100 stops in a short time, a probability detecting an irregular motion of one's upper body decreases and thus a walking judgment processing frequency reduces, so that it becomes possible to reduce the electric power consumption. Further, a probability of false detection decreases as well.

Reversely, even in a case where the person momentarily stops in order to open a door and immediately reopens the walking, since the operation of the walking detection circuit 100 does not stop for 5 seconds of the walking stop judgment time, a step number measurement accuracy does not decrease.

Since the pause time is made 5 seconds during an initial one minute, even in a case where the walking is reopened in a short time like the signal wait, the step number measurement accuracy does not decrease large because the walking detection can be reopened in the short time.

Further, if there continues the state in which there is no walking signal, since the pause time is gradually prolonged, in a case where the person is sleeping and thus the pedometer is not being carried, an operation time of the detection circuit 100 can be made short as far as possible, so that it becomes possible to reduce the electric power consumption.

Further, even if the pause time is 30 seconds in the maximum, if the walking signal enters, since it is returned to 5 seconds of an initial value which is a minimum value, the fact that the step number measurement accuracy decreases large becomes only a walking start time, so that there is brought about such an advantage that the step number measurement accuracy does not decrease large in a unit day.

Incidentally, in the present embodiment, although there is constituted such that the whole detection circuit 100 is switched to one of the continuous drive and the intermittent drive, there may be constituted such that one section, such as the amplification circuit 102 or 104, in the detection circuit 100 is switched to the continuous drive and the intermittent drive.

Further, although there is explained with the example of an arm pedometer, it can be applied to various pedometers such as a pedometer used by being worn to a waist, or a pedometer used under a state accommodated in a carrying bag.

Further, although the acceleration sensor is used as a walking sensor, there may be used a mechanical sensor, a pressure sensor provided in a shoe bottom, or the like.

Besides the arm pedometer used with the sensor being worn at least to the arm, the present invention can be applied to various pedometers such as the pedometer used by being worn to the waist, or the pedometer used under the state accommodated in the carrying bag.

What is claimed is:

1. A pedometer having:
a detection means having a sensor detecting a walking and outputting a walking signal corresponding to the walking detected by the sensor,
a calculation means calculating a step number on the basis of the walking signal from the detection means, and
a control means which, in a case where the walking signal is not continuously outputted for a predetermined time from the detection means, controls an operation of the detection means so as to shift from a continuous operation continuously detecting the walking to an intermittent operation in which there are alternately repeated a pause operation pausing a walking detection in a pause time and a detection operation performing the walking detection in a detection time,
wherein the control means controls the detection means such that the pause time becomes gradually long in a case where the walking signal is not outputted from the detection means at a time of the intermittent operation.

2. A pedometer according to claim 1, wherein the control means controls the detection means such that an upper limit of the pause time becomes a predetermined time.

3. A pedometer according to claim 2, wherein, in a case shifting to the intermittent operation again after returning to the continuous operation from the intermittent operation, the control means controls the detection means so as to reopen the intermittent operation by returning the pause time to a minimum value.

4. A pedometer according to claim 1, wherein, in a case shifting to the intermittent operation again after returning to the continuous operation from the intermittent operation, the control means controls the detection means so as to reopen the intermittent operation by returning the pause time to a minimum value.
